(19) United States
(12) Patent Application Publication
(10) Pub. No.: US 2017/0166731 A1
(43) Pub. Date: Jun. 15, 2017

(54) EPOXIDIZED POLYISOPRENE RUBBER COMPOSITION

(71) Applicants: COMPAGNIE GENERALE DES ETABLISSEMENTS MICHELIN, CLERMONT-FERRAND (FR); MICHELIN RECHERCHE ET TECHNIQUE S.A., GRANGES-PACCOT (CH)

(72) Inventors: AURÉLIE JOSEPH, CLERMONT-FERRAND (FR); JULIEN CLADIERE, CLERMONT-FERRAND (FR)

(21) Appl. No.: 15/116,917

(22) PCT Filed: Jan. 27, 2015
(86) PCT No.: PCT/EP2015/051590

§ 371 Date: Aug. 5, 2016

(30) Foreign Application Priority Data
Feb. 7, 2014 (FR) 1450965

(51) Int. Cl. C08L 7/00; C08C 19/06; C08K 3/04; C08L 15/00; B60C 1/00; C08K 3/36

(52) U.S. Cl. CPC C08L 7/00; B60C 1/0016; C08K 3/36; C08K 3/04; C08L 15/00; C08C 19/06

(57) ABSTRACT

The present invention relates to a rubber composition which improves the compromise between stiffness in the cured state and the hysteresis of the composition. The rubber composition comprises from 0 to less than 20 phr of a butyl rubber, from more than 50 to 100 phr of a polyisoprene matrix, the polyisoprene matrix containing an epoxidized polyisoprene having a molar degree of epoxidation ranging from 5% to less than 50%, a carbon black and a silica, the weight of carbon black being greater than 50% of the total weight of carbon black and silica, from 0 to less than 2 phr of a coupling agent, and a crosslinking system. The epoxidized polyisoprene is an epoxidized natural rubber or an epoxidized synthetic polyisoprene having a molar content of 1,4-cis bonds of at least 90% before epoxidation, or a mixture thereof, and, if the epoxidized polyisoprene is an epoxidized polyisoprene having a molar degree of epoxidation of from 5% to 25%, the rubber composition contains more than 50 phr of epoxidized polyisoprene.

The field of the present invention is that of rubber compositions, reinforced by a reinforcing filler, which may be used for the manufacture of tyres for vehicles.

A rubber composition reinforced by a reinforcing filler must fulfil a number of often contradictory technical requirements when it is used in a tyre. It may be required that a rubber composition used in a part of the tyre has both a certain degree of stiffness in the cured state, and as low a hysteresis as possible. To increase the stiffness in the cured state of a rubber composition, it is known, for example, to increase the content of filler or to introduce styrene/butadiene copolymers with a high styrene content into the rubber composition. However, these solutions generally have the drawback of increasing the hysteresis of the rubber composition. The use of a hysteretic composition in a tyre may be apparent by a rise in the internal temperature of the tyre, which may lead to a reduction in the durability of the tyre.

In the light of the foregoing, it is a constant aim to provide rubber compositions with an improved compromise between stiffness in the cured state and hysteresis.

The applicants have discovered that a specific composition makes it possible to achieve this aim.

Thus, a first subject of the invention is a rubber composition comprising:
from 0 to less than 20 phr of a butyl rubber,
from more than 50 to 100 phr of a polyisoprene matrix, the polyisoprene matrix containing an epoxidized polyisoprene having a molar degree of epoxidation ranging from 5% to less than 50%,
a carbon black and a silica, the weight of carbon black being greater than 50% of the total weight of carbon black and silica,
from 0 to less than 2 phr of a coupling agent,
a crosslinking system, the epoxidized polyisoprene being an epoxidized natural rubber or an epoxidized synthetic polyisoprene having a molar content of 1,4-cis bonds of at least 90% before epoxidation, or a mixture thereof,
with the proviso that, if the epoxidized polyisoprene is an epoxidized polyisoprene having a molar degree of epoxidation of from 5% to 25%, the rubber composition contains more than 50 phr of epoxidized polyisoprene.

The invention also relates to a tyre comprising the rubber composition in accordance with the invention.

The invention also relates to a process for manufacturing the rubber composition in accordance with the invention.

The invention also relates to a process for manufacturing the tyre in accordance with the invention.

### I. DETAILED DESCRIPTION OF THE INVENTION

In the present description, unless expressly indicated otherwise, all the percentages (%) shown are % by weight. The abbreviation “phr” means parts by weight per hundred parts of elastomer present in the rubber composition.

Furthermore, any interval of values denoted by the expression “between a and b” represents the range of values greater than “a” and less than “b” (that is to say, limits a and b excluded), whereas any interval of values denoted by the expression “from a to b” means the range of values extending from “a” up to “b” (that is to say, including the strict limits a and b).

“Polyisoprene matrix” is intended to mean all the polyisoprenes and epoxidized polyisoprenes present in the rubber composition.

“Polyisoprene” is intended to mean a polyisoprene which is not epoxidized. The polyisoprene may be natural rubber, a synthetic polyisoprene having a molar content of 1,4-cis bonds of at least 90%, or else a mixture thereof.

“Epoxidized polyisoprene” is intended to mean an epoxidized natural rubber or an epoxidized synthetic polyisoprene having a molar content of 1,4-cis bonds of at least 90% before epoxidation, or a mixture thereof.

The epoxidized polyisoprene which constitutes all or part of the polyisoprene matrix is an elastomer, and is not to be confused with an epoxidized polyisoprene of low molar mass, generally used as plasticizer. An epoxidized polyisoprene, as elastomer, generally has a high Mooney viscosity in the uncured state. The Mooney viscosity (ML 1+4) at 100° C. of the epoxidized polyisoprene is preferentially greater than 20, more preferentially greater than 30, and even more preferentially greater than 40. It is also generally less than or equal to 150. By way of indication, the Mooney viscosities (ML 1+4) at 100° C. of natural rubbers epoxidized to 25 mol % may be of the order of 40 to 150. The ranges of the Mooney viscosity of the epoxidized polyisoprene are preferentially from 30 to 150, more preferentially from 40 to 150, and even more preferentially from 50 to 140. These preferential values for Mooney viscosity apply to any one of the embodiments of the invention.

Mooney viscosity is measured by means of an oscillating consistometer as described in Standard ASTM D1646 (1999). The measurement is carried out according to the following principle: the sample, analysed in the uncured state (i.e., before curing), is moulded (shaped) in a cylindrical chamber heated to a given temperature (for example 100° C.). After preheating for 1 minute, the rotor rotates within the test specimen at 2 revolutions/minute and the working torque for maintaining this movement is measured after rotating for 4 minutes. Mooney viscosity (ML 1+4) is expressed in “Mooney unit” (MU, with 1 MU=0.83 newton.metre).

The epoxidized polyisoprene, whether it is an epoxidized natural rubber or an epoxidized synthetic polyisoprene, may be obtained in a known way by epoxidation of polyisoprene, for example by processes based on chlorohydrin or bromohydrin or processes based on hydrogen peroxides, alkyl hydroperoxides or peracids (such as peracetic acid or performic acid). Epoxidized polyisoprenes are commercially available. The molar degree of epoxidation, which is data provided by the suppliers, corresponds to the ratio of the number of moles of epoxidized isoprene units to the number of moles of isoprene units in the polyisoprene before epoxidation.

According to the present invention, the term “an epoxidized polyisoprene” must be understood as one or more epoxidized polyisoprenes which may be distinguished either by their microstructure, their macrostructure or their degree of epoxidation. In the case of several epoxidized polyisoprenes in the polyisoprene matrix, reference to the amount of epoxidized polyisoprene in the polyisoprene matrix applies to the total weight of the epoxidized polyisoprenes in the polyisoprene matrix. For example, the feature according to which the epoxidized polyisoprene is present in the rubber composition at a content of greater than 50 phr means that, in the case of a mixture of epoxidized polyisoprenes, the total weight of epoxidized polyisoprenes is greater than 50 phr.

In the case in which the epoxidized polyisoprene is a mixture of epoxidized polyisoprenes which may differ from one another by their molar degree of epoxidation, reference to a molar degree of epoxidation, whether preferential or not, applies to each of the epoxidized polyisoprenes of the mixture.

In the case in which the epoxidized polyisoprene is an epoxidized polyisoprene having a molar degree of epoxidation of from 5% to 25%, the rubber composition contains more than 50 phr of epoxidized polyisoprene. In other words, given the above definitions, when the polyisoprene matrix contains no other epoxidized polyisoprene than an epoxidized polyisoprene having a molar degree of epoxidation of from 5 to 25% or than a mixture of epoxidized polyisoprenes each having a molar degree of epoxidation of from 5 to 25%, the rubber composition contains more than 50 phr of this epoxidized polyisoprene or of this mixture of epoxidized polyisoprenes. A minimum content of more than 50 phr of such an epoxidized polyisoprene in the rubber composition makes it possible to improve the compromise of properties between stiffness, shear modulus at 100% elongation, and hysteresis of the composition in the cured state.

According to one preferential embodiment of the invention, the epoxidized polyisoprene is an epoxidized natural rubber.

According to a particular embodiment of the invention, the polyisoprene matrix contains a polyisoprene having a molar content of 1,4-cis bonds of at least 90%. According to this particular embodiment of the invention, the polyisoprene matrix is preferably a mixture of a polyisoprene having a molar content of 1,4-cis bonds of at least 90% and the epoxidized polyisoprene. According to this particular embodiment, in its preferential form or not, the polyisoprene having a molar content of 1,4-cis bonds of at least 90% is natural rubber.

The epoxidized polyisoprene, whether resulting from the epoxidation of a synthetic polyisoprene or of natural rubber, has a molar degree of epoxidation ranging from 5% to less than 50%. When the molar degree of epoxidation is less than 5%, the targeted technical effect is considered to be insufficient, while at a content of greater than or equal to 50%, the composition becomes too stiff. The molar degree of epoxidation is preferentially from 5 to 40%, more preferentially from 5 to 35%, and even more preferentially from 10 to 35%.

According to one most particularly preferential embodiment of the invention, the epoxidized polyisoprene is an epoxidized polyisoprene having a molar degree of epoxidation of from 5 to 30%, preferentially from 5 to 25%.

The content of the polyisoprene matrix in the rubber composition is from more than 50 phr to 100 phr. The content of the polyisoprene matrix in the rubber composition is preferentially greater than 80 phr, more preferentially equal to 100 phr. These preferential embodiments are especially advantageous for use of the rubber composition as a rubber component in a tyre, for example, as a tyre tread for a vehicle intended to bear heavy loads, in particular from the perspective of the durability of the tyre.

According to the embodiment in which the epoxidized polyisoprene is an epoxidized polyisoprene having a molar degree of epoxidation of from 5 to 35%, preferably from 5 to 30%, more preferentially from 5 to 25%, the content of epoxidized polyisoprene is preferentially greater than 80 phr, more preferentially equal to 100 phr.

When the content of the polyisoprene matrix is less than 100 phr, the rubber composition in accordance with the invention contains another elastomer, preferentially a diene elastomer.

A “diene” elastomer (or rubber) should be understood, in a known way, as an (or several) elastomer composed, at least in part (i.e., a homopolymer or a copolymer), of diene monomer units (monomers bearing two conjugated or non-conjugated carbon-carbon double bonds).

These diene elastomers can be classified into two categories: “essentially unsaturated” or “essentially saturated”. “Essentially unsaturated” is generally intended to mean a diene elastomer resulting at least in part from conjugated diene monomers having a content of units of diene origin (conjugated dienes) which is greater than 15% (mol %); thus, diene elastomers such as butyl rubbers or copolymers of dienes and of a-olefins of EPDM type do not come under the above definition and can especially be described as “essentially saturated” diene elastomers (low or very low content of units of diene origin, always less than 15%). In the category of “essentially unsaturated” diene elastomers, “highly unsaturated” diene elastomer is intended to mean in particular a diene elastomer having a content of units of diene origin (conjugated dienes) which is greater than 50%.

Given these definitions, “diene elastomer capable of being used in the compositions in accordance with the invention” is intended more particularly to mean:

(a) any homopolymer of a conjugated diene monomer, especially any homopolymer obtained by polymerization of a conjugated diene monomer having from 4 to 12 carbon atoms;

(b) any copolymer obtained by copolymerization of one or more conjugated dienes with one another or with one or more vinylaromatic compounds having from 8 to 20 carbon atoms.

In the case of copolymers of type (b), the latter contain from 20 to 99% by weight of diene units and from 1 to 80% by weight of vinylaromatic units.

The following are suitable in particular as conjugated diener: 1,3-butadiene, 2-methyl-1,3-butadiene, 2,3-di(C₁-C₅ alkyl)-1,3-butadienes, such as, for example, 2,3-dimethyl-1,3-butadiene, 2,3-diethyl-1,3-butadiene, 2-methyl-3-ethyl-1,3-butadiene or 2-methyl-3-isopropyl-1,3-butadiene, an aryl-1,3-butadiene, 1,3-pentadiene or 2,4-hexadiene.

The following, for example, are suitable as vinylaromatic compounds: styrene, ortho-, meta- or para-methylstyrene, the “vinyltoluene” commercial mixture, para-(tert-butyl)styrene, methoxystyrenes, chlorostyrenes, vinylmesitylene, divinylbenzene or vinylnaphthalene.

The diene elastomer is preferably an essentially unsaturated diene elastomer selected from the group consisting of polybutadienes, butadiene copolymers, isoprene copolymers and the mixtures thereof.

The rubber composition in accordance with the invention has the essential feature of containing from 0 to less than 20 phr of a butyl rubber. “Butyl rubber” is intended to mean copolymers of isoprene and of isobutylene, in particular those which are halogenated. According to any one of the embodiments of the invention, the content of butyl rubber in the rubber composition is preferentially from 0 to 10 phr, more preferentially from 0 to 5 phr. Advantageously, the rubber composition in accordance with the invention is devoid of butyl rubber.

The rubber composition has the essential feature of comprising a carbon black and a silica. The weight of carbon black is greater than 50% of the total weight of carbon black and silica.

All carbon blacks, especially the blacks conventionally used in tyres or their treads (“tyre-grade” blacks), are suitable as carbon blacks. Among the latter, mention will more particularly be made of the reinforcing carbon blacks of the 100, 200 and 300 series, or the blacks of the 500, 600 or 700 series (ASTM grades), such as, for example, the N115, N134, N234, N326, N330, N339, N347, N375, N550, N683 and N772 blacks. These carbon blacks may be used on their own, as available commercially, or in any other form, for example as support for some of the rubber-making additives used. Among the latter, mention will more particularly be made of the reinforcing carbon blacks of the 100, 200 or 300 series (ASTM grade), such as, for example, the N115, N134, N234 or N375 blacks.

According to one preferential embodiment of the invention, the carbon black has a BET specific surface area of at least 90 m²/g, preferably of at least 100 m²/g. The BET specific surface area of the carbon blacks is measured according to Standard D6556-10 [multipoint (at least 5 points) method—gas:nitrogen—relative pressure P/P0 range: 0.01 to 0.5].

The silica used may be any silica known to those skilled in the art, capable of reinforcing, by itself alone, without means other than an intermediate coupling agent, a rubber composition intended for the manufacture of pneumatic tyres; in other words able to replace, in its reinforcing role, a conventional tyre-grade carbon black.

The silica used may be a precipitated or fumed silica having a BET surface area and a CTAB specific surface area both of less than 450 m²/g, preferably from 30 to 400 m²/g, especially between 60 and 300 m²/g. As an example of silica of use for the requirements of the invention, mention may be made of the Ultrasil VN3 silica sold by Evonik. As highly dispersible precipitated silicas (“HDSs”), mention will be made, for example, of the Ultrasil 7000 and Ultrasil 7005 silicas from Degussa, the Zeosil 1165MP, 1135MP and 1115MP silicas from Rhodia, the Hi-Sil EZ150G silica from PPG, the Zeopol 8715, 8745 and 8755 silicas from Huber and the silicas having a high specific surface area as described in Application WO 03/016387.

The physical state in which the silica is present is of no concern, whether it is in the form of powder, micropearls, granules or else beads. Of course, “silica” is also intended to mean mixtures of various silicas.

To make the silica reinforcing in a composition of diene rubber, it is known practice to use a coupling agent to couple the silica to the diene elastomer. The at least bifunctional coupling agent (or bonding agent), which is most often a silane, makes it possible to provide a satisfactory chemical and/or physical connection between the inorganic filler (surface of its particles) and the diene elastomer. Use is made in particular of at least bifunctional organosilanes or polyorganosiloxanes. The content of the coupling agent is from 0 to less than 2 phr.

As coupling agent, use is made especially of silane polysulphides, referred to as “symmetrical” or “asymmetrical” depending on their specific structure, such as described, for example, in applications WO 03/002648 (or US 2005/016651) and WO 03/002649 (or US 2005/016650).

Particularly suitable, without the definition below being limiting, are silane polysulphides corresponding to the general formula (V):

Z-A-Sₓ-A-Z (V)
in which:
x is an integer from 2 to 8 (preferably from 2 to 5);
the A symbols, which are identical or different, represent a divalent hydrocarbon radical (preferably a C₁-C₁₈ alkylene group or a C₆-C₁₂ arylene group, more particularly a C₁-C₁₀, especially C₁-C₄, alkylene, in particular propylene);
the Z symbols, which are identical or different, correspond to one of the three formulae below:

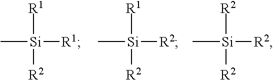

in which:
the R¹ radicals, which are substituted or unsubstituted and identical to or different from one another, represent a C₁-C₁₈ alkyl, C₅-C₁₈ cycloalkyl or C₆-C₁₈ aryl group (preferably C₁-C₆ alkyl, cyclohexyl or phenyl groups, in particular C₁-C₄ alkyl groups, more particularly methyl and/or ethyl);
the R² radicals, which are substituted or unsubstituted and identical to or different from one another, represent a C₁-C₁₈ alkoxyl or C₅-C₁₈ cycloalkoxyl group (preferably a group selected from C₁-C₈ alkoxyls and C₅-C₈ cycloalkoxyls, more preferentially still a group selected from C₁-C₄ alkoxyls, in particular methoxyl and ethoxyl).

In the case of a mixture of alkoxysilane polysulphides corresponding to the above formula (I), especially customary commercially available mixtures, the mean value of “x” is a fractional number preferably of between 2 and 5, more preferentially close to 4. However, the invention may also be advantageously carried out, for example, with alkoxysilane disulphides (x=2).

As examples of silane polysulphides, mention will more particularly be made of bis((C₁-C₄)alkoxyl(C₁-C₄)alkylsilyl(C₁-C₄)alkyl) polysulphides (especially disulphides, trisulphides or tetrasulphides), such as, for example, bis(3-trimethoxysilylpropyl) or bis(3-triethoxysilylpropyl) polysulphides. Among these compounds, use is made in particular of bis(3-triethoxysilylpropyl) tetrasulphide, abbreviated to TESPT, of formula [(C₂H₅O)₃Si(CH₂)₃S₂]₂, or bis(triethoxysilylpropyl) disulphide, abbreviated to TESPD, of formula [(C₂H₅O)₃Si(CH₂)₃S]₂.

As coupling agent other than alkoxysilane polysulphide, mention will especially be made of bifunctional POSs (polyorganosiloxanes), or else of hydroxysilane polysulphides, such as described in patent applications WO 02/30939 (or U.S. Pat. No. 6,774,255) and WO 02/31041 (or US 2004/051210), or else of silanes or POSs bearing azodicarbonyl functional groups, such as described, for example, in patent applications WO 2006/125532, WO 2006/125533 and WO 2006/125534.

According to one embodiment of the invention, the content of carbon black in the rubber composition is from 30 to 90 phr, preferentially from 30 to 70 phr, and more preferentially from 35 to 60 phr. These preferential ranges apply to any one of the embodiments of the invention.

According to one preferential embodiment of the invention, the content of silica used is greater than 0 phr and less than or equal to 35 phr; it preferably ranges from 2 to 35 phr, preferably from 3 to 30 phr and especially from 5 to 20 phr. These preferential ranges apply to any one of the embodiments of the invention.

According to one embodiment of the invention, the rubber composition contains a covering agent for the silica. Among the covering agents for the silica, mention may be made, for example, of hydroxysilanes or hydrolysable silanes such as hydroxysilanes (see, for example, WO 2009/062733), alkylalkoxysilanes, especially alkyltriethoxysilanes such as, for example, 1-octyltriethoxysilane, polyols (for example diols or triols), polyethers (for example polyethylene glycols), primary, secondary or tertiary amines (for example trialkanolamines), an optionally substituted guanidine, especially diphenylguanidine, hydroxylated or hydrolysable polyorganosiloxanes (for example α,ω-dihydroxypolyorganosilanes, especially α,ω-dihydroxypolydimethylsiloxanes) (see, for example, EP 0 784 072), and fatty acids such as, for example, stearic acid. When a covering agent for the silica is used, it is used at a content of between 0 and 5 phr. The rubber composition in accordance with the invention preferably contains a polyethylene glycol as covering agent for the silica.

According to one embodiment of the invention, the rubber composition comprises from 0 to less than 1 phr, more preferentially from 0 to less than 0.5 phr of a coupling agent. This embodiment, whether in its preferential form or not, applies to any one of the embodiments of the invention.

According to one preferential embodiment of the invention, the rubber composition does not contain coupling agent, which amounts to saying that the content of the coupling agent is equal to 0 phr. According to this embodiment, silica is not considered to be a reinforcing filler. According to this embodiment, the rubber composition preferably contains a covering agent for the silica, such as those mentioned above, for example. The covering agent for the silica is preferentially a polyethylene glycol.

According to this preferential embodiment, in which silica is not considered to be a reinforcing filler, carbon black is preferably the only reinforcing filler present in the rubber composition.

“Reinforcing filler” is intended to mean nanoparticles with a (weight-)average size of less than a micrometre, generally less than 500 nm, most often between 20 and 200 nm, in particular and more preferentially between 20 and 150 nm.

The crosslinking system may be based on sulphur, sulphur donors, peroxide, bismaleimides or mixtures thereof.

According to any one of the embodiments of the invention, the crosslinking system is preferentially a vulcanization system, that is to say a system based on sulphur (or on a sulphur donor agent) and on a primary vulcanization accelerator. Various known secondary vulcanization accelerators or vulcanization activators, such as zinc oxide, stearic acid or equivalent compounds, or guanidine derivatives (in particular diphenylguanidine), or else known vulcanization retarders, may be added to this basic vulcanization system, being incorporated during the first non-productive phase and/or during the productive phase, as described subsequently.

When sulphur is used, it is used at a preferential content of between 0.5 and 12 phr, in particular between 1 and 10 phr. The primary vulcanization accelerator is used at a preferential content of between 0.5 and 10 phr, more preferentially of between 0.5 and 5.0 phr.

As (primary or secondary) accelerator, use may be made of any compound capable of acting as accelerator for the vulcanization of diene elastomers in the presence of sulphur, especially accelerators of the thiazole type, and also their derivatives, and accelerators of sulphenamide, thiuram, dithiocarbamate, dithiophosphate, thiourea and xanthate types.

As examples of such accelerators, mention may especially be made of the following compounds: 2-mercaptobenzothiazyl disulphide (abbreviated to MBTS), N-cyclohexyl-2-benzothiazolesulphenamide (CBS), N,N-dicyclohexyl-2-benzothiazolesulphenamide (DCBS), N-(tert-butyl)-2-benzothiazolesulphenamide (TBBS), N-(tert-butyl)-2-benzothiazolesulphenimide (TBSI), tetrabenzyl thiuram disulphide (TBZTD), zinc dibenzyldithiocarbamate (ZBEC) and the mixtures of these compounds.

The rubber composition in accordance with the invention may also comprise all or some of the customary additives usually used in rubber compositions intended to constitute mixtures of finished rubber articles such as tyres, such as for example plasticizers or extending oils, pigments, protection agents such as antiozone waxes, chemical antiozonants, antioxidants and antifatigue agents.

According to any one of the embodiments of the invention, the amount of plasticizer, especially oil or other plasticizer which is liquid at 23° C., is preferentially less than 10 phr, more preferentially less than 5 phr.

The rubber composition may be manufactured in appropriate mixers, using two successive phases of preparation well known to those skilled in the art: a first phase of thermomechanical working or kneading (“non-productive” phase) at high temperature, up to a maximum temperature of between 110° C. and 200° C., followed by a second phase of mechanical working (“productive” phase) down to a lower temperature, typically below 110° C., for example between 40° C. and 100° C., during which finishing phase the crosslinking system is incorporated.

The process for preparing the rubber composition in accordance with the invention comprises the following steps:
adding the carbon black, the silica and, if appropriate, the coupling agent to the polyisoprene matrix during a first “non-productive” step by kneading thermomechanically until a maximum temperature of between 110° C. and 200° C. is reached,
cooling the combined mixture to a temperature of less than 110° C.,
subsequently incorporating the crosslinking system,
kneading everything up to a maximum temperature of less than 110° C. in order to obtain a mixture.

After incorporating all the ingredients of the rubber composition, the final composition thus obtained is then calendered, for example in the form of a sheet or a slab, especially for laboratory characterization, or else extruded, for example in order to form a rubber profiled element used as a rubber component for producing the tyre. The rubber composition in accordance with the invention may be used in calendering form in a tyre.

Thus, according to one specific embodiment of the invention, the rubber composition in accordance with the invention, being able to be either in the uncured state (before crosslinking or vulcanization) or in the cured state (after crosslinking or vulcanization), is in a tyre, for example in a tyre tread.

The tyre, which is another subject of the invention and contains the rubber composition in accordance with the invention, may be either in the uncured state (before crosslinking or vulcanization) or in the cured state (after crosslinking or vulcanization), which composition may be in the form of a calendering or of an extrudate in order to form a rubber component of the tyre.

The tyre may be prepared according to the process comprising the following steps:
adding the carbon black, the silica and, if appropriate, the coupling agent to the polyisoprene matrix during a first “non-productive” step by kneading thermomechanically until a maximum temperature of between 110° C. and 200° C. is reached,
cooling the combined mixture to a temperature of less than 110° C.,
subsequently incorporating the crosslinking system,
kneading everything up to a maximum temperature of less than 110° C. in order to obtain a mixture,
calendering or extruding the mixture obtained.

The abovementioned characteristics of the present invention, and also others, will be better understood on reading the following description of several exemplary embodiments of the invention, which are given by way of non-limiting illustration.

### II. EXEMPLARY EMBODIMENTS OF THE INVENTION

II.1—Measurements and Tests Used:

Dynamic Properties:

The dynamic properties are measured on a viscosity analyser (Metravib VA4000) according to Standard ASTM D 5992-96. The response of a sample of vulcanized composition (cylindrical test specimen with a height of 4 mm and with a cross section of 400 mm²), subjected to a simple alternating sinusoidal shear stress, at a frequency of 10 Hz, at 80° C. and at 100° C., is recorded. A strain amplitude sweep is carried out from 0.1% to 100% (outward cycle) and then from 100% to 0.1% (return cycle). The results made use of are the complex dynamic shear modulus G* and the loss factor tan(δ). The value of the G* at 50% strain and also the loss factor, denoted tan(δ)ₘₐₓ, are recorded on the return cycle.

The results are expressed in base 100, the value 100 being assigned to the control. A result of less than 100 indicates a decrease in the value concerned and, conversely, a result of greater than 100 indicates an increase in the value concerned.

Tensile Tests:

These tests are carried out in accordance with French Standard NF T 46-002 of September 1988. At second elongation (that is to say after accommodation) the nominal secant modulus, calculated with respect to the initial cross section of the test specimen, (or apparent stress, in MPa) is measured at 10% and 100% elongation, denoted ASM10 and ASM100, respectively.

All these tensile measurements are carried out under the standard conditions of temperature (23±2° C.) and hygrometry (50±5% relative humidity), according to French Standard NF T 40-101 (December 1979).

The results are expressed in base 100, the value 100 being assigned to the control. A result of less than 100 indicates a decrease in the value concerned and, conversely, a result of greater than 100 indicates an increase in the value concerned.

II.2—Preparation of the Rubber Compositions:

Composition C1 is the control composition which is customarily used in a tyre tread for a vehicle intended to bear heavy loads, in particular running on stony ground, such as a tyre for a civil engineering vehicle. Composition C2 is in accordance with the invention. The detail of the formulations of composition C1 and C2 is described in Table I. Composition C2 differs from composition C1 in that it contains an epoxidized natural rubber.

Compositions C1 and C2 are prepared in accordance with the process described above.

The compositions thus obtained are subsequently calendered, either in the form of slabs (with a thickness ranging from 2 to 3 mm) or thin sheets of rubber, for the measurement of their physical or mechanical properties, or in the form of profiled elements which can be used directly, after cutting and/or assembling to the desired dimensions.

II.3—Properties of the Rubber Compositions:

The results of the dynamic properties and the tensile tests are found in Tables II and III, respectively.

Composition C2 in accordance with the invention has a G* value, at 50%, which is far greater than that of control composition C1 not in accordance with the invention, both at 80° C. and at 100° C. Moreover, it is noted that the values of tan(δ)ₘₐₓ at 80° C. and at 100° C. of composition C2 are lower than those of control composition C1, which reflects the fact that composition C2 is less hysteretic than control composition C1. It is also noted that the moduli ASM10 and ASM100 of composition C2 are higher than those of the control composition. The results demonstrate that the invention makes it possible to produce a significant increase in the stiffness in the cured state of the rubber composition, without detrimentally affecting the hysteresis of the rubber composition. Rather, a decrease in the hysteresis of the rubber composition is observed.

In summary, the rubber composition in accordance with the invention has an improved compromise between the stiffness in the cured state and the hysteresis. The rubber composition in accordance with the invention may be used advantageously in a part of a tyre for which such a compromise between the stiffness in the cured state and the hysteresis is required. Used, for example, in a tyre tread, the rubber composition in accordance with the invention makes it possible to improve the performance compromise between the wear resistance and the endurance of the tyre.

TABLE I

| Composition | C1 | C2 |
|---|---|---|
| NR (1) | 100.00 | — |
| ENR25 (2) | — | 100.00 |
| Silica (3) | 15.00 | 15.00 |
| Black (4) | 40.00 | 40.00 |
| Antioxidant (5) | 2.50 | 2.50 |
| Paraffin | 1.00 | 1.00 |
| PEG (6) | 2.50 | 2.50 |
| ZnO | 2.70 | 2.70 |
| Stearic acid | 1.00 | 1.00 |
| Sulphur | 1.70 | 1.70 |
| Accelerator (7) | 1.10 | 1.10 |

(1) Natural rubber
(2) Natural rubber epoxidized to 25%
(3) Ultrasil VN3 silica from Evonik
(4) N115 from Cabot
(5) N-(1,3-Dimethylbutyl)-N-phenyl-para-phenylenediamine, Santoflex 6-PPD from Flexsys
(6) Polyethylene glycol, Carbowax 8000 from Dow Corning
(7) N-cyclohexyl-2-benzothiazolesulphenamide (Santocure CBS from Flexsys)

TABLE II

| Composition | C1 | C2 |
|---|---|---|
| G*(50%) at 100° C. | 100 | 116 |
| tan(δ)ₘₐₓ at 100° C. | 100 | 92 |
| G*(50%) at 80° C. | 100 | 115 |
| tan(δ)ₘₐₓ at 80° C. | 100 | 93 |

TABLE III

| Composition | C1 | C2 |
|---|---|---|
| ASM10 at 23° C. | 100 | 120 |
| ASM100 at 23° C. | 100 | 120 |

1.-28. (canceled)

29. A rubber composition comprising:
from 0 to less than 20 phr of a butyl rubber;
from more than 50 to 100 phr of a polyisoprene matrix, the polyisoprene matrix containing an epoxidized polyisoprene having a molar degree of epoxidation ranging from 5% to less than 50%;
a carbon black and a silica, the weight of carbon black being greater than 50% of the total weight of carbon black and silica;
from 0 to less than 2 phr of a coupling agent; and
a crosslinking system,
wherein the epoxidized polyisoprene is an epoxidized natural rubber or an epoxidized synthetic polyisoprene having a molar content of 1,4-cis bonds of at least 90% before epoxidation, or a mixture thereof, and
wherein, if the epoxidized polyisoprene is an epoxidized polyisoprene having a molar degree of epoxidation of from 5% to 25%, the rubber composition contains more than 50 phr of epoxidized polyisoprene.

30. The rubber composition according to claim 29, wherein the content of the coupling agent is from 0 to less than 1 phr.

31. The rubber composition according to claim 30, wherein the content of the coupling agent is from 0 to less than 0.5 phr.

32. The rubber composition according to claim 31, wherein the content of the coupling agent is equal to 0 phr.

33. The rubber composition according to claim 29, wherein the content of carbon black is from 30 to 90 phr.

34. The rubber composition according to claim 33, wherein the content of carbon black is from 30 to 70 phr.

35. The rubber composition according to claim 34, wherein the content of carbon black is from 35 to 60 phr.

36. The rubber composition according to claim 29, wherein the content of silica is greater than 0 phr and less than or equal to 35 phr.

37. The rubber composition according to claim 36, wherein the content of silica is from 2 to 35 phr.

38. The rubber composition according to claim 29, wherein the carbon black has a BET specific surface area of at least 90 m²/g.

39. The rubber composition according to claim 38, wherein the carbon black has a BET specific surface area of at least 100 m²/g.

40. The rubber composition according to claim 29, wherein the composition comprises a covering agent for the silica.

41. The rubber composition according to claim 40, wherein the covering agent is a polyethylene glycol.

42. The rubber composition according to claim 29, wherein the crosslinking system is a vulcanization system.

43. The rubber composition according to claim 29, wherein the epoxidized polyisoprene is an epoxidized natural rubber.

44. The rubber composition according to claim 29, wherein the epoxidized polyisoprene is an epoxidized polyisoprene having a molar degree of epoxidation of from 5% to 35%.

45. The rubber composition according to claim 44, wherein the epoxidized polyisoprene is an epoxidized polyisoprene having a molar degree of epoxidation of from 5% to 30%.

46. The rubber composition according to claim 45, wherein the epoxidized polyisoprene is an epoxidized polyisoprene having a molar degree of epoxidation of from 5% to 25%.

47. The rubber composition according to claim 29, wherein the epoxidized polyisoprene is an epoxidized polyisoprene having a molar degree of epoxidation of from 5% to 40%.

48. The rubber composition according to claim 47, wherein the epoxidized polyisoprene is an epoxidized polyisoprene having a molar degree of epoxidation of from 10% to 35%.

49. The rubber composition according to claim 29, wherein the content of the polyisoprene matrix is greater than 80 phr.

50. The rubber composition according to claim 29, wherein the content of epoxidized polyisoprene is greater than 80 phr.

51. The rubber composition according to claim 50, wherein the content of epoxidized polyisoprene is equal to 100 phr.

52. The rubber composition according to claim 29, wherein the polyisoprene matrix contains a polyisoprene having a molar content of 1,4-cis bonds of at least 90%.

53. The rubber composition according to claim 52, wherein the polyisoprene matrix is a mixture of the polyisoprene having a molar content of 1,4-cis bonds of at least 90% and the epoxidized polyisoprene.

54. The rubber composition according to claim 52, wherein the polyisoprene having a molar content of 1,4-cis bonds of at least 90% is natural rubber.

55. The rubber composition according to claim 29, wherein the content of butyl rubber is from 0 to 10 phr.

56. The rubber composition according to claim 55, wherein the content of butyl rubber is from 0 to 5 phr.

57. The rubber composition according to claim 56, wherein the content of butyl rubber is 0 phr.

58. The rubber composition according to claim 29 further comprising another diene elastomer.

59. The rubber composition according to claim 58, wherein the another diene elastomer is an essentially unsaturated diene elastomer selected from the group consisting of polybutadienes, butadiene copolymers, isoprene copolymers and mixtures thereof.

60. The rubber composition according to claim 29, wherein the content of the polyisoprene matrix is equal to 100 phr.

61. A process for preparing the rubber composition according to claim 29 comprising the steps of:
adding the carbon black, the silica and, if present, the coupling agent to the polyisoprene matrix during a first non-productive step by kneading thermomechanically until a maximum temperature of between 110° C. and 200° C. is reached;
cooling the mixture to a temperature of less than 110° C.;
subsequently incorporating the crosslinking system;
kneading the mixture up to a maximum temperature of less than 110° C. in order to obtain the rubber composition.

62. A tire comprising a rubber composition according to claim 29.

63. A process for preparing the tire according to claim 62 comprising the steps of:
adding the carbon black, the silica and, if present, the coupling agent to the polyisoprene matrix during a first non-productive step by kneading thermomechanically until a maximum temperature of between 110° C. and 200° C. is reached;
cooling the mixture to a temperature of less than 110° C.;
subsequently incorporating the crosslinking system;
kneading up to a maximum temperature of less than 110° C. in order to obtain the rubber composition;
calendering or extruding the rubber composition obtained.
